(19) United States
(12) Patent Application Publication
(10) Pub. No.: US 2015/0132096 A1
(43) Pub. Date: May 14, 2015

(54) APPARATUS FOR MOVING AND GROUPING FLAT PRODUCTS

(71) Applicant: SPS ITALIANA PACK SYSTEMS S.p.A., TORREBELVICINO (Vicenza) (IT)

(72) Inventors: Fabio Masini, Oleggio (Novara) (IT); Paolo Puricelli, Cavallirio (Novara) (IT)

(73) Assignee: SPS ITALIANA PACK SYSTEMS S.P.A., TORREBELVICINO (Vicenza) (IT)

(21) Appl. No.: 14/383,772

(22) PCT Filed: Mar. 8, 2013
(86) PCT No.: PCT/IB2013/051849

§ 371 Date: Sep. 8, 2014

(30) Foreign Application Priority Data
Mar. 9, 2012 (IT) TO2012A000211

(51) Int. Cl. B65G 47/08; B65G 59/06; B65G 19/02

(52) U.S. Cl. CPC B65G 47/08; B65G 19/02; B65G 59/067
USPC 414/797.7; 414/801

(57) ABSTRACT

The apparatus for moving and grouping flat products (10) having two main faces and a perimetral edge comprises: a conveyor device (16) from which catch elements (18) suitable for pushing the products (10) along a longitudinal conveying direction protrude; a plurality of magazines (22) which contain stacks of products (10) and are arranged in succession along the conveying direction above the conveyor device (16); respective guide members arranged below the bottom end of each magazine (22) and suitable for guiding products (10) exiting from the magazine (22) towards the conveyor device (16); and a respective pair of rotating elements associated with the bottom end of each magazine (22). The elements of each pair are respectively arranged on the sides of the magazine (22) and above the guide members so that the products (10) exiting from the bottom of the respective magazine (22) are subjected, on different portions of their edge (12), to the combined and contemporaneous action of the rotating elements and of a catch element (18).

The present invention relates to an apparatus for moving and grouping flat products, in particular biscuits, having a perimetral edge and two main faces. With such an apparatus it is possible to remove products from several magazines or loaders inside which they are stacked and to form piles of the desired height—typically formed by a predefined number of products—on a conveyor device directed towards a station for packaging the piles.

EP-A-0 868 349 and the corresponding U.S. Pat. No. 6,189,678 describe a known apparatus of this kind comprising a conveyor device from which catch elements for pushing the products and a plurality of magazines which contain stacks of the products protrude and are arranged in succession along the conveyor device. In this apparatus the catch elements push the bottom products of each stack—which are supported by adjustable—height supports—so as to direct them on the conveyor device.

The interaction between the catch element and each product to be transferred is moreover concentrated in a restricted region of the latter, which may easily result in damage thereto considering the friability of the material from which biscuits are typically made.

This known apparatus is moreover provided with rotating elements which are associated with the bottom end of each magazine and which act exclusively as selective supports for the stack of products contained therein, allowing, following their temporary rotation, one or more bottom products to fall onto the conveyor device. These elements are therefore static during the stage of transfer of the products from the respective magazine to the conveyor device, during which stage they act as stationary supports for the stack of products, and are rotated only when the level of the surface supporting the products in the magazine must be varied or the conditions for enabling/disabling falling of the products from the magazine onto the conveying device are switched.

EP-A-2 172 398 describes another type of known apparatus of the kind indicated at the start of the present description, in which a wheel for removing a product from the bottom of the respective stack so as to impart to it a certain speed is arranged underneath each loader. The subsequent impact with a catch element protruding from the conveyor device is therefore dampened, since the difference between the respective speeds has been reduced, such that there is less risk of breakage. Furthermore, the wheel is arranged eccentrically with respect to the central longitudinal axis of the conveyor device such that its impact generates a force which is not aligned with the direction of advancing movement of the conveyor and acts on the products so as to impart to them a “launching” action. Consequently, in this case also, the products may be subject to relatively high stresses. Furthermore, they must be necessarily extracted from the loader one at a time.

BE-366 205, describes another type of known apparatus of the type indicated at the start of the present description, in which a pair of horizontal-axis wheels suitable for removing a product from the bottom of the respective stack so as to impart to it a certain speed are arranged underneath the central portion of a loader. The subsequent impact with a catch element protruding from the conveyor device is therefore dampened, since the difference between the respective speeds has been reduced. Moreover, since the wheels are arranged underneath the central portion of the loader, their action is exerted substantially on the same edge portion of the product which will be pushed by the catch element, dangerously increasing the stresses transmitted in this restricted area. Moreover, the wheels, which have an axis parallel to the plane in which the products lie, exert on the latter a transverse force parallel to their smaller dimension, i.e. their thickness, which in the case of fragile products, such as dry biscuits, is the prelude to breakages.

The object of the present invention is therefore to provide an improved apparatus compared to those of the prior art.

According to the invention this object is achieved by means of an apparatus having the features mentioned specifically in claim 1 below. Preferred features of the apparatus according to the invention are described in the dependent claims.

In the apparatus according to the invention, each product exiting from the respective loader is pushed jointly by a catch element and by two rotating elements, which respectively act on the central zone and on the lateral zones, so that the pushing action is homogeneous and symmetrical, reducing considerably the risk of breakage due to violent and/or asymmetrical contact.

Moreover, the apparatus according to the invention may extract from each loader more than one product during each working cycle, this being limited only by the geometrical volume of the products and the various components and not by the nature of the movement operations performed, with a consequent increase in productivity.

A further subject of the present invention is a method for moving and grouping flat products, which envisages using the aforementioned apparatus.

Further advantages and features of the present invention will become clear from the detailed description which follows, provided purely by way of a non-limiting example with reference to the accompanying drawings in which:

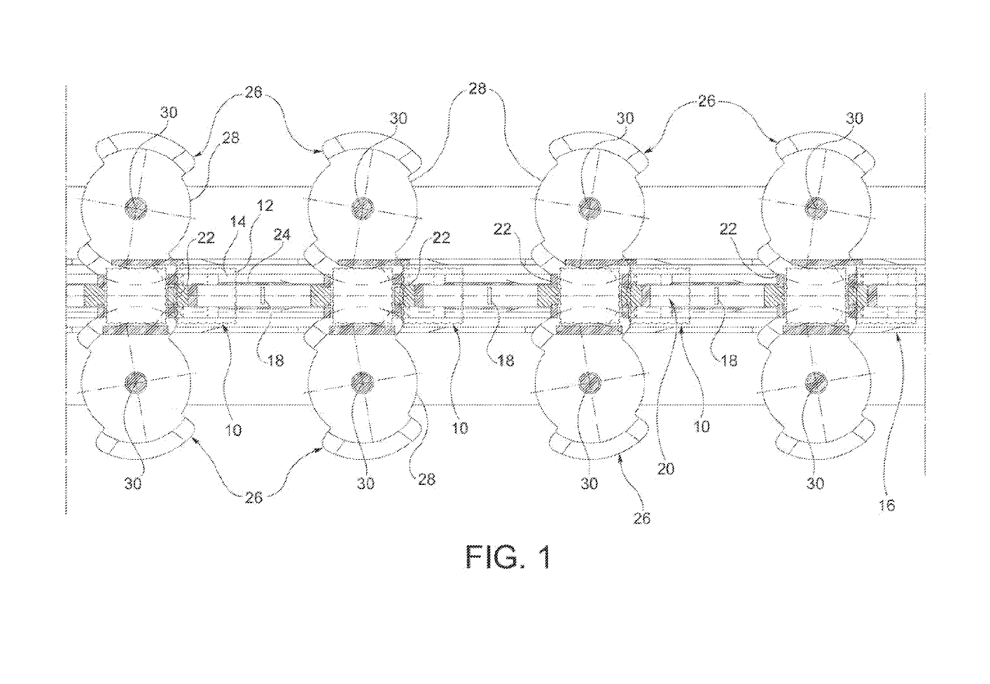

FIG. 1 is a schematic plan view of an apparatus according to the invention;

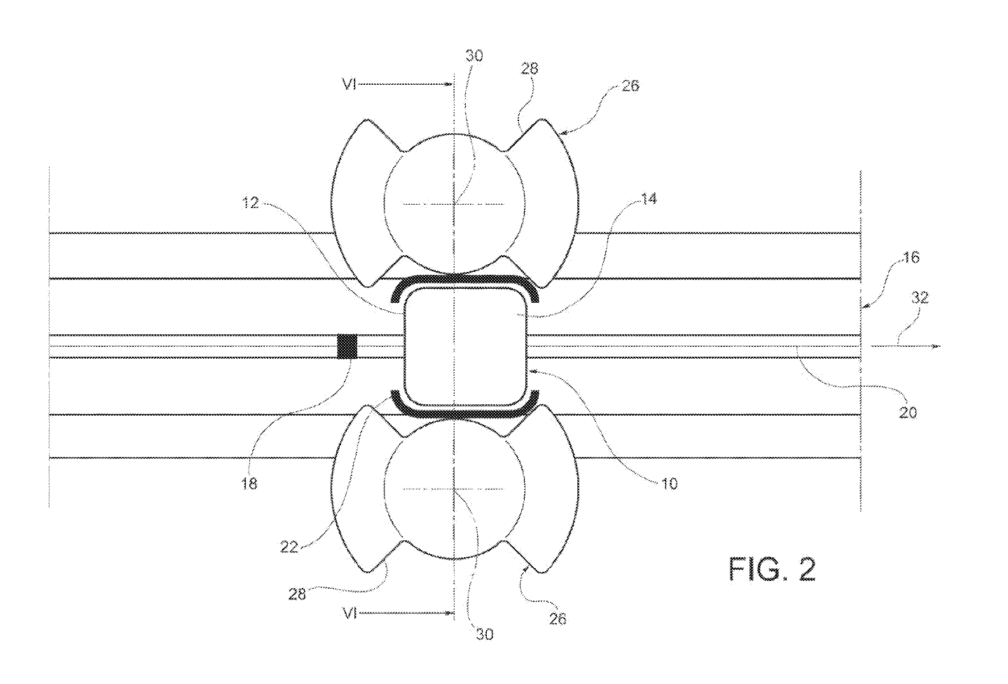

FIGS. 2 to 5 illustrate schematically successive operating steps of a loader of the apparatus according to FIG. 1;

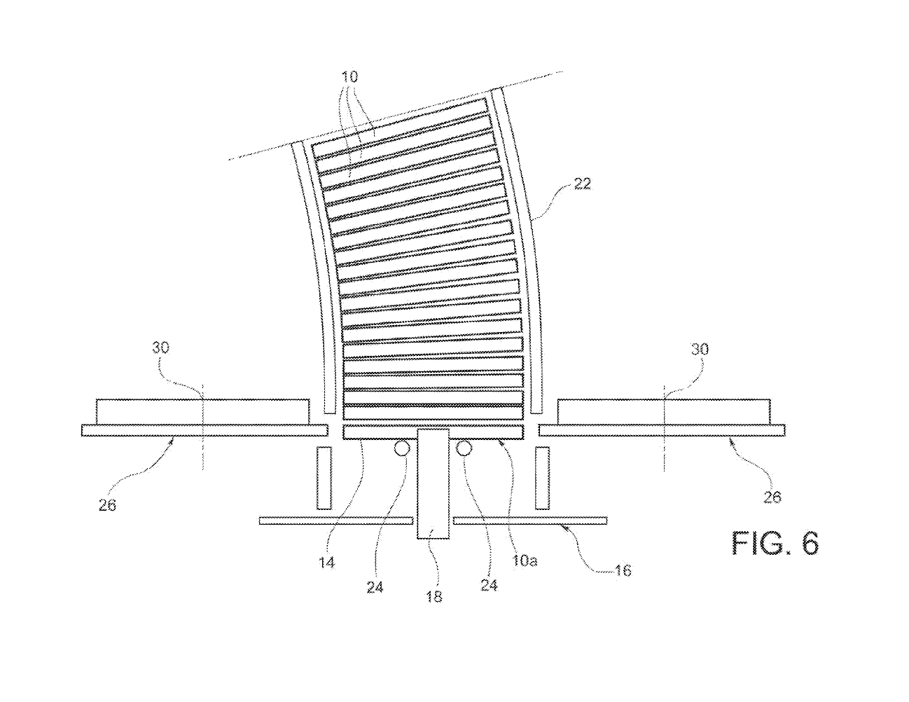

FIG. 6 is a cross-sectional view along the line VI-VI of FIG. 2;

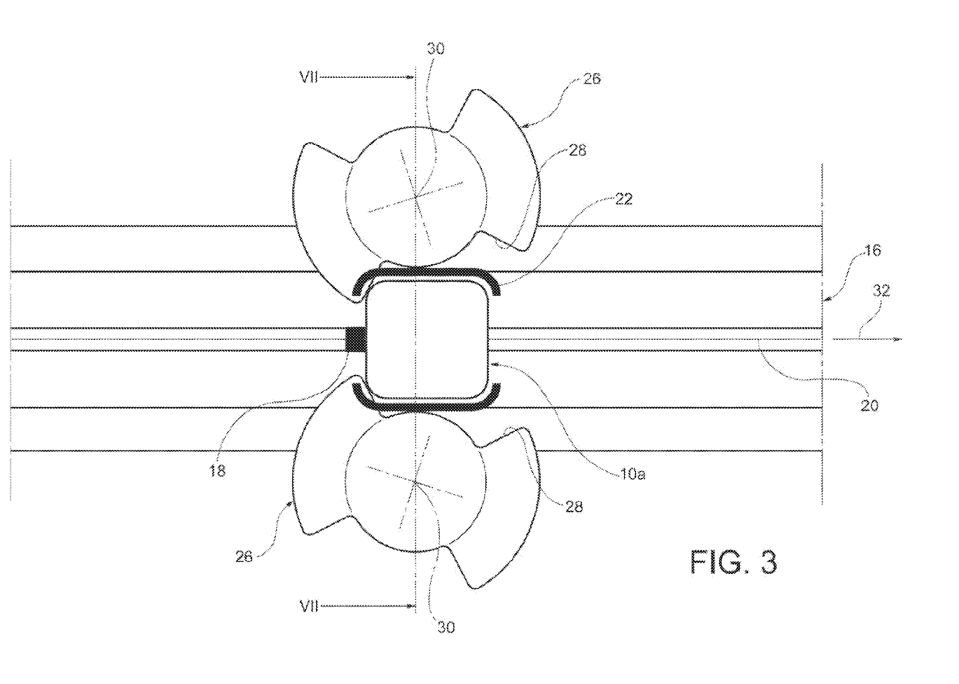

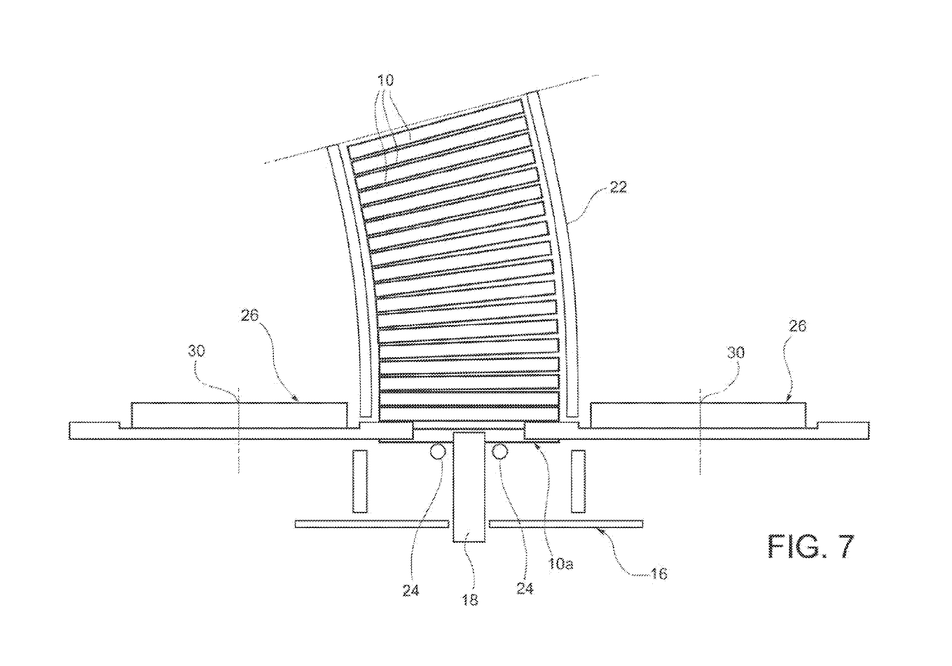

FIG. 7 is a cross-sectional view along the line VII-VII of FIG. 3; and

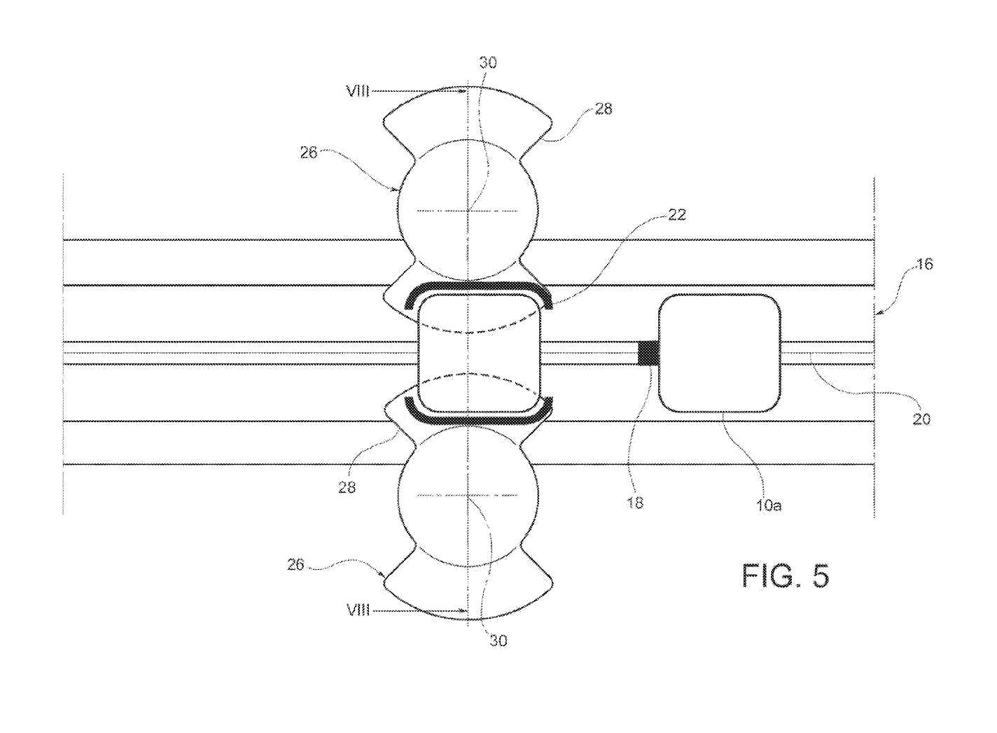

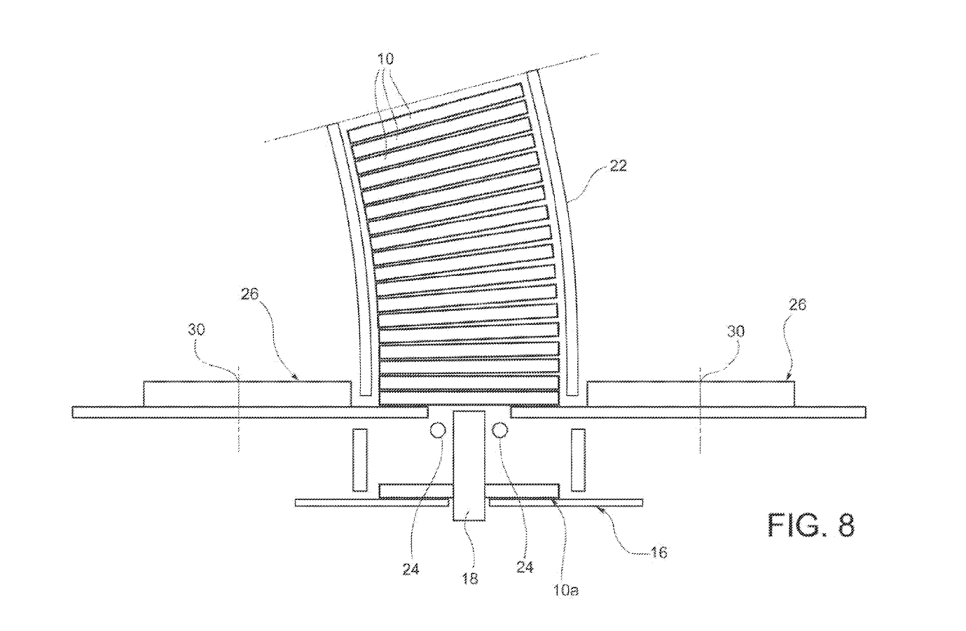

FIG. 8 is a cross-sectional view along the line VIII-VIII of FIG. 5.

FIG. 1 shows an apparatus for moving and grouping flat products 10, in particular biscuits, having a perimetral edge 12 and two main faces 14 (FIGS. 2-8).

The apparatus comprises a conveyor device 16 from which catch elements 18 suitable for pushing the products 10 along a conveying direction coinciding with the longitudinal axis 20 of the conveyor device 16 protrude.

A plurality of magazines or loaders 22 which contain stacks of products 10 and are arranged in succession above the conveyor device 16 are arranged along the conveying direction.

Each magazine 22 has, arranged underneath its bottom end, members suitable for guiding the products which exit from it towards the conveyor device 16 and comprising a pair of bars 24 arranged symmetrically along the sides of the longitudinal axis 20. The bars 24 thus define a channel for the passage of the catch elements 18 along the longitudinal axis 20.

Each magazine 22 has arranged at its bottom end a respective pair of rotating elements consisting of wheels 26 arranged symmetrically along the sides of the respective magazine 22 and having along their perimetral edge two symmetrically arranged recesses 28. In variations of embodiment not shown the wheels 26 could have only one recess or more than two recesses. Furthermore, the thickness of the wheels 26 may be variable, for example having a ramp-like profile. The wheels 26 have axes 30 which are parallel to each other as well as to the axis of the bottom end portion of the respective magazine 22. These axes 30 are instead substantially at right angles to the horizontal plane passing through the longitudinal conveying axis 20. The wheels 26 lie substantially horizontally above the horizontal plane passing through the portion of the guide bars 24 situated underneath the respective magazine 22.

During operation, the conveyor device 16, to which the catch elements 18 are fixed, slides in the longitudinal direction defined by the arrow 32 in FIG. 2. In the condition shown in FIG. 2, one of the respective recesses 28 of the wheels 26 faces the magazine 22 with which they are associated so as to leave the discharge aperture of the magazine free. The last product 10a of the stack may thus fall from the bottom end of the magazine 22 onto the underlying section of the bars 24 (FIG. 6). When a catch element 18 starts to move towards the product 10a, the wheels 26 start to rotate about the respective axis 30 so that the product 10a is subjected (FIGS. 3 and 7) to the combined and contemporaneous pushing action of the wheels 26 and the catch element 18. In particular, the latter pushes the central portion of the edge 12 of the rear portion of the product 10a, while radial sides of the recesses 28 of the wheels 26 push the respective sides portions of this edge 12. In other words, the products 10 exiting from the bottom of the respective magazine 22 are subjected to the pushing action of the catch element 18 on the portion of their edge 12 which is situated along the longitudinal axis 20 of the conveyor device 16 and to the pushing action of the wheels 26 on the respective portions of their edge which are substantially furthest from the axis 20.

Advantageously, this simultaneous pushing action takes place during the initial stage of the exiting movement of the product 10a from the magazine 22. It is moreover possible that there is a slight discrepancy during the initial stages of contact between the product 10a and on the one hand the wheels 26 and on the other hand the catch element 18 which makes contact initially. In any case, there will always be a period of time during which combined and contemporaneous pushing of the product 10a by the wheels 26 and the catch element 18 will take place.

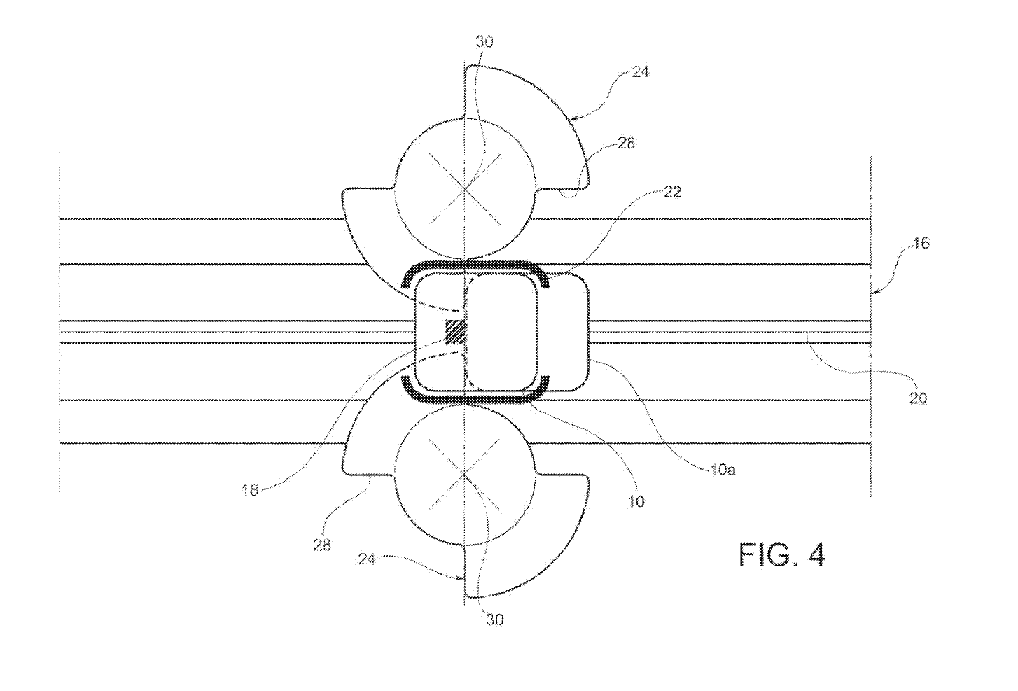

As a result, the product 10a, subjected to the combined and contemporaneous pushing action of the wheels 26 and the catch element 18, is pushed along the axis 20 of the device 16 (FIG. 4), until it is no longer subjected to the action of the wheels 26, but only to that of the catch element 18 (FIG. 5). The weight of the product 10a is supported by the bars 24 which, in a manner known per se, are profiled so as to lower gradually, allowing gradual and soft deposition of the product 10a onto the conveying surface of the device 16 (FIG. 8). During this latter rotation, the wheels 26 act as a floor for the magazine 22, preventing falling of what has now become the last product in the stack until the start of a new working cycle similar to that described above.

In a manner conventional per se, the products 10 discharged from the magazines 22 onto the conveyor device 16 form piles which are typically formed by a predetermined number of products which are then sent to a packaging station. A major feature of the apparatus according to the invention consists in the fact that the pushing action on the product 10a during the delicate transition phase from the magazine 22 to the conveyor device 16 is homogeneous and symmetrical, reducing considerably the risk of breakages due to violent and/or asymmetrical contact. The products 10 are therefore handled with care and suitably supported during the whole of transfer step from the bottom of the respective magazine 22 to the conveyor device 16, such that they may be moved at very fast rates—about 600 or more units per minute per magazine—thereby speeding up significantly operation. Moreover, as a result of this delicate handling action, it is possible to move suitably also any broken products which thus must not be discarded, but are kept assembled and processed in a manner similar to that of the unbroken products.

For the sake of simplicity, reference has been made to the extraction from the magazine 22 of a single product 10a for each rotation cycle of the wheels. It is nevertheless possible to extract more than one product per cycle, varying the positioning height of the bars 24 and the wheels 26, without being subject to particular constraints except those determined by the geometrical volume of the products 10 and the various components of the apparatus.

It should also be noted that each of the magazines 22 and the associated wheels 26 may be operated independently of the other magazines 22. In this way it is possible to avoid the generation of rejects during start-up and stoppage and continue operation of the apparatus in a satisfactory manner, even when a single magazine and/or the line supplying the products 10 is not functioning for some unforeseen reason. This independent operating mode also allows discharging of the products 10 from the various magazines to be performed in a balanced manner as desired.

Of course, without modifying the principle of the invention, the constructional details and the embodiments may be greatly varied with respect to that described purely by way of example, without thereby departing from the scope of the invention as defined in the accompanying claims.

1. Apparatus for moving and grouping flat products (10) having two main faces (14) and a perimetral edge (12), comprising:
a conveyor device (16) from which catch elements (18) suitable for pushing said products (10) along a longitudinal conveying direction protrude,
a plurality of magazines (22) which contain stacks of said products (10) and are arranged in succession along the conveying direction above said conveyor device (16),
respective guide members arranged below the bottom end of each magazine (22) and suitable for guiding products (10) exiting from the magazine (22) towards the conveyor device (16), and
a respective pair of rotating elements associated with the bottom end of each magazine (22), the elements of each pair being respectively arranged on the sides of the magazine (22) and above the guide members, and having axes (30) parallel to each other and parallel to the axis of the bottom end portion of the respective magazine (22),
said apparatus being characterized in that said rotating elements are pushing members of said products (10) along the longitudinal conveying direction, in such a way that, during use of the apparatus, the products (10) exiting from the bottom of the respective magazine (22) are subjected, on different portions of their edge (12), to the combined and contemporaneous action of said rotating elements and of a catch element (18), during at least a part of the exiting movement.

2. Apparatus according to claim 1, wherein said rotating elements are wheels (26) symmetrically arranged on the sides of the respective magazine (22) and having at least one recess (28) along their perimetral edge.

3. Apparatus according to claim 2, wherein said wheels (26) have two symmetrically arranged recesses.

4. Apparatus according to claim 1, wherein said guide members arranged below the bottom end of each magazine (22) comprise a pair of bars (24) symmetrically arranged on the sides of a longitudinal axis (20) of the conveyor device (16), so as to define a channel for the passage of the catch elements (18) along the said longitudinal axis (20).

5. Apparatus according to claim 1, wherein the products (10) exiting from the bottom of the respective magazine (22) are subjected to the combined and contemporaneous action on their edge (12) of said rotating elements and a catch element (18) during the initial part of the exiting movement from the magazine (22).

6. Method for moving and grouping flat products (10) having two main faces (14) and a perimetral edge (12), which envisages using an apparatus comprising:
a conveyor device (16) from which catch elements (18) suitable for pushing said products (10) along a longitudinal conveying direction protrude,
a plurality of magazines (22) which contain stacks of said products (10) and are arranged in succession along the conveying direction above said conveyor device (16),
respective guide members arranged below the bottom end of each magazine (22) and suitable for guiding products (10) exiting from the magazine (22) towards the conveyor device (16), and
a respective pair of rotating elements, in particular wheels (26), associated with the bottom end of each magazine (22), the elements of each pair being respectively arranged on the sides of the magazine (22) and above the guide members, and having axes (30) parallel to each other and parallel to the axis of the bottom end portion of the respective magazine (22).
in which method said rotating elements act as pushing members of said products (10) along the longitudinal conveying direction, in such a way that the products (10) exiting from the bottom of the respective magazine (22) are subjected, on different portions of their edge (12), to the combined and contemporaneous action of said rotating elements and of a catch element (18), during at least a part of the exiting movement.

7. Method according to claim 6, wherein the products (10) exiting from the bottom of the respective magazine (22) are subjected to the combined and contemporaneous action on their edge (12) of said rotating elements and of a catch element (18) during the initial part of the exiting movement from the magazine (22).

8. Method according to claim 6, wherein the products (10) exiting from the bottom of the respective magazine (22) are subjected to the combined and contemporaneous action on their edge (12) of said rotating elements and of a catch element (18) during the initial part of the exiting movement from the magazine (22), with a possible slight discrepancy during the initial stages of contact between the product (10) and on the one hand the rotating elements and on the other hand the catch element (18) which makes contact initially.

9. Method according to claim 6, wherein the products (10) exiting from the bottom of the respective magazine (22) are subjected to the pushing action of the catch element (18) on the portion of their edge (12) which is situated along a longitudinal axis (20) of the conveyor device (16) and to the pushing action of said rotating elements on the respective portions of their edge which are furthest from said longitudinal axis (20).

10. Method according to claim 6, wherein the products (10) exit from the bottom of each magazine (22) at a rate of at least 600 units per minute.

11. Method according to claim 6, wherein the rotating elements which act as pushing member and are associated with each magazine (22) are operated independently of those associated with the other magazines (22).
